(19) United States
(12) Patent Application Publication
(10) Pub. No.: US 2018/0309851 A1
(43) Pub. Date: Oct. 25, 2018

(54) SERVER TERMINAL DEVICE, CLIENT TERMINAL DEVICE, THIN CLIENT SYSTEM, CONTROL METHOD, AND PROGRAM RECORDING MEDIUM

(71) Applicant: NEC Corporation, Minato-ku, Tokyo (JP)

(72) Inventor: Kenji FUJISAKI, Tokyo (JP)

(73) Assignee: NEC Corporation, Minato-ku, Tokyo (JP)

(21) Appl. No.: 15/770,802

(22) PCT Filed: Oct. 25, 2016
(86) PCT No.: PCT/JP2016/004688

§ 371 Date: Apr. 25, 2018

(30) Foreign Application Priority Data
Oct. 28, 2015 (JP) 2015-211802

(51) Int. Cl. H04L 29/06; G06F 9/455

(52) U.S. Cl. CPC H04L 67/42; G06F 2009/45595; G06F 9/45558

(57) ABSTRACT

The purpose of the present invention is to provide a thin client system which is capable of using terminal information of a client terminal. A server terminal device comprises software which is executed on the server terminal device, and a transfer platform which transmits to a client terminal device a screen image which the software generates, and receives operation information from the client terminal. The transfer platform receives terminal information of the client terminal from the client terminal, and provides the received terminal information to the software.

### TECHNICAL FIELD

The present invention relates to a server terminal device, a client terminal device, a thin client system, a control method, and a program recording medium.

### BACKGROUND ART

There is a system of a form called a thin client system. For the thin client system, there are some implementation schemes. As a typical implementation scheme, there is a scheme called a screen transfer-type scheme. The screen transfer-type scheme is to transfer, to a client terminal device, a screen image generated by an application or the like that operates on a server terminal device. By browsing the transmitted screen image displayed by the client terminal device, a user recognizes information provided by an application that operates on the server terminal device and performs an operation on an application that operates on the server terminal device, for an interface included in the screen image.

For example, PTL 1 discloses a technology for transferring a screen image by considering performance of a client terminal in a screen transfer-type thin client system. By using the technology disclosed in PTL 1, it becomes possible, for example, to transfer a screen image adapted to a resolution of a display of a client terminal device.

A thin client system can limit a client terminal device to having a minimum necessary function and minimum necessary information. By utilizing this characteristic, important information can be gathered in a server terminal device. A thin client system is sometimes introduced for the purpose of taking a security measure to prevent information leakage and the like from a client terminal device. A general thin client system often utilizes a stationary-type desktop personal computer (PC) or a dedicated terminal device as a client terminal device. On the other hand, in recent years, a mobile terminal device such as a smartphone and a tablet terminal device achieves widespread use, therefore, there exists a need to utilize a thin client system from a mobile terminal device. In response to this, a product that enables utilization of a thin client system from a mobile terminal device has been provided.

### CITATION LIST

### Patent Literature

### [PTL 1]

Japanese Unexamined Patent Application Publication No. 2009-163142

### SUMMARY OF INVENTION

### Technical Problem

Notably, when a mobile terminal device is utilized, there is a need different from a need when a PC or the like is utilized. For example, some services utilized by connecting to the Internet from a mobile terminal device request identification information (e.g., a telephone number) unique to each mobile terminal. Also when a thin client system is utilized from a mobile terminal device, there is a need, for example, to utilize information unique to the mobile terminal device for authentication or the like in an application that operates on a server terminal device. However, such a need cannot be fulfilled by a generally-provided thin client system.

Furthermore, when a mobile terminal device is utilized, there is a need to keep track of a battery remaining amount and a current communication state. However, in order to check a battery remaining amount and the like when utilizing a mobile terminal device in a generally-provided thin client system, a screen of the thin client system needs to be switched for checking, to a screen generated by an OS or the like that operates on the mobile terminal device, which causes a user to feel burdensome.

The present invention therefore has an object to provide a server terminal device, a client terminal device, a thin client system, a control method, and a program recording medium that can solve the above-mentioned problems.

### Solution to Problem

A present invention is a server terminal device which includes:

a transfer platform that transmits, to a client terminal device, a screen image generated by software executed on the server terminal device, and receives, from the client terminal device, operation information relating to the screen image, wherein the transfer platform further receives terminal information on the client terminal device from the client terminal device, and provides the received terminal information to the software.

Further, the present invention is a client terminal device which includes:

a connecting unit that receives a screen image from the above-described server terminal device, and

transmits operation information relating to the screen image to the server terminal device, wherein

the connecting unit collects terminal information on the server terminal device, and transmits the collected terminal information to the server terminal device.

Further, the present invention is a thin client system which includes:

the above-described server terminal device and the client terminal device.

Further, the present invention is a control method which includes:

by a server terminal device that transmits, to a client terminal device, a screen image generated by software executed on the server terminal device, and receives, from the client terminal device, operation information relating to the screen image,

receiving terminal information on the client terminal device from the client terminal device; and providing the received terminal information for the software.

Further, the present invention is a program recoding medium that records a program causing

a computer in a server terminal device that transmits, to a client terminal device, a screen image generated by software executed on the server terminal device, and receives, from the client terminal device, operation information relating to the screen image,

to function as means for receiving terminal information on the client terminal device from the client terminal device, and providing the received terminal information for the software.

### Advantageous Effects of Invention

According to the present invention, in a thin client system, software that operates on a server terminal device can utilize terminal information on a client terminal device.

### BRIEF DESCRIPTION OF DRAWINGS

FIG. 1 is a diagram illustrating a minimum configuration of a server terminal device pertaining to a thin client system according to a first example embodiment of the present invention;

FIG. 2 is a block diagram of the thin client system according to the first example embodiment of the present invention;

FIG. 3 is a diagram illustrating an example of setting information used for setting processing of terminal information according to the first example embodiment of the present invention;

FIG. 4 is a diagram for describing setting processing of terminal information performed by a terminal information setting unit in the first example embodiment of the present invention;

FIG. 5 is a flowchart illustrating an example of transmission/reception processing of unique information performed by a thin client system in the first example embodiment of the present invention;

FIG. 6 is a flowchart illustrating an example of transmission/reception processing of state information performed by the thin client system in the first example embodiment of the present invention; and

FIG. 7 is a diagram illustrating a utilization example of the thin client system according to the first example embodiment of the present invention.

### DESCRIPTION OF EMBODIMENTS

### First Example Embodiment

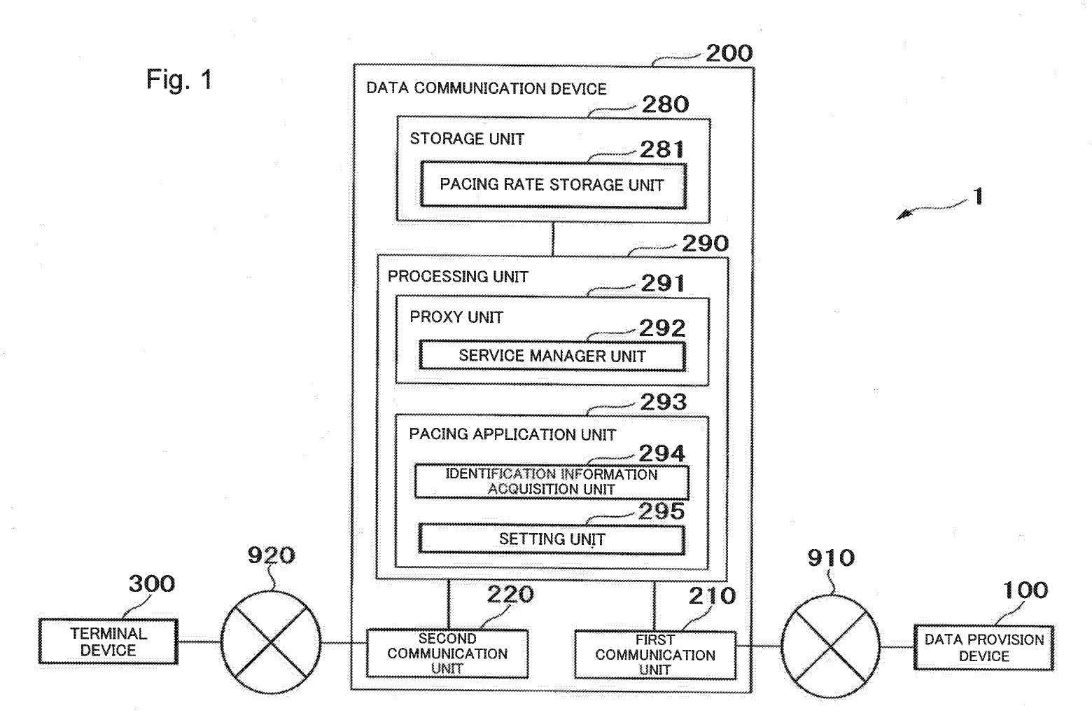

With reference to FIGS. 1 to 7, a thin client system according to a first example embodiment of the present invention will hereinafter be described.

FIG. 1 is a diagram illustrating a minimum configuration of a server terminal device pertaining to the thin client system according to the first example embodiment of the present invention.

As illustrated in FIG. 1, a server terminal device 200 has at least a transfer platform 210.

The transfer platform 210 transmits, to a client terminal device, a screen image generated by software that runs on the server terminal device 200, via a communication interface provided in the server terminal device 200. Furthermore, the transfer platform 210 receives, from the client terminal device, operation information input into the client terminal device in relation to the transmitted screen image by using an input device such as a keyboard or a touch panel, via the communication interface. The transfer platform 210 is, for example, platform middleware implemented in a server terminal device in a screen transfer-type thin client system. Further in the present example embodiment, the transfer platform 210 receives, from a client terminal device, terminal information on the client terminal device, and provides the received terminal information to software executed on the server terminal device 200. Providing terminal information means directly or indirectly outputting terminal information to targeted software, a targeted functioning unit, and the like. Terminal information will be mentioned later.

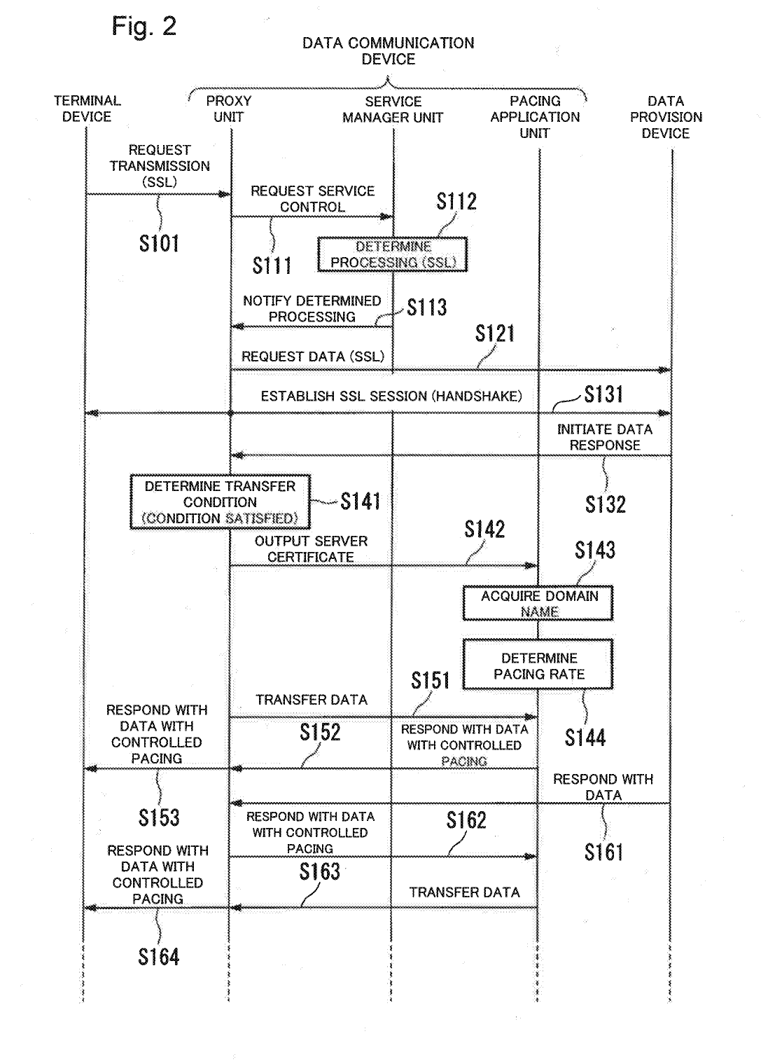

FIG. 2 is a block diagram of the thin client system according to the first example embodiment of the present invention.

As illustrated in FIG. 2, a thin client system 10 is configured to include a client terminal device 100 and the server terminal device 200. The thin client system 10 is a screen transfer-type thin client system. The client terminal device 100 and the server terminal device 200 are connected via a network.

The client terminal device 100 includes a physical machine OS 110, a virtual machine connecting unit 120, a unique information storage unit 130, and a state information storage unit 140. The client terminal device 100 is a mobile terminal device such as a smartphone.

The physical machine OS 110 is an operating system (OS) that operates on the client terminal device 100.

The virtual machine connecting unit 120 receives a screen image from the server terminal device 200 via a communication interface provided in the client terminal device 100, and displays the screen image on a display provided in the client terminal device 100. Furthermore, the virtual machine connecting unit 120 acquires operation information that a user inputs into the client terminal device 100, and transmits the acquired operation information to the server terminal device 200 via the communication interface. The operation information is, for example, a touch operation such as tapping or flicking on a touch panel configured integrally with the display provided in the client terminal device 100, a pressing operation on a button provided in the client terminal device 100, and the like. Furthermore, the virtual machine connecting unit 120 collects terminal information on the client terminal device 100, and transmits the collected terminal information to the server terminal device 200. The terminal information is, for example, information unique to a device (hereinafter called unique information) such as information that is set in association with the client terminal device 100, an example of which is an international mobile equipment identity (IMEI), or information relating to a specification or a design determined for the client terminal device 100. Furthermore, the terminal information indicates, for example, information that changes depending on an environment in which the client terminal device 100 is utilized or changes with a lapse of time (hereinafter called state information). This includes a state or an operation of a device and a function provided in the client terminal device 100, an example of which is battery remaining amount. The terminal information includes unique information and state information.

The unique information storage unit 130 stores unique information. The unique information is information unique to the client terminal device 100 (a physical machine), among information that can be acquired at an application interface of the device. Examples of the unique information include an IMEI, a mobile equipment identifier (MEID), a telephone number, an international mobile subscriber identity (IMSI), an integrated circuit card ID (ICCID), a WIFI (registered trademark) MAC address, a Bluetooth (registered trademark) MAC address, a model number or a serial number of the client terminal device 100, firmware version, a device (a camera, a payment function, and the like) uniquely provided in the client terminal device 100, a screen size, and a resolution.

The state information storage unit 140 stores state information. The state information is information that changes depending on a state of the client terminal device 100, among information that can be acquired at an application interface of the client terminal device 100. Examples of the state information include radio field intensity, communication state, line type, location information provided by GPS, battery remaining amount, voice information, VPN information, WIFI setting information, language setting, and time-of-day/time zone settings. Each of various sensors provided in the client terminal device 100 records detected radio field intensity, detected battery remaining amount, detected location information, and the like in the state information storage unit 140.

The server terminal device 200 includes the transfer platform 210, a virtualization hypervisor 220, and a virtual machine 230. The transfer platform 210 is as described with use of FIG. 1. The virtualization hypervisor 220 is a virtualization platform that executes the virtual machine 230. The virtualization hypervisor 220 acquires terminal information from the transfer platform 210, and provides the terminal information to the virtual machine 230. The virtual machine 230 is software that operates to simulate a function of the server terminal device on the virtualization hypervisor 220.

The virtual machine 230 includes a virtual machine OS 231, a virtual machine application 232, a unique information storage unit 233, a state information storage unit 234, a setting information storage unit 235, and a terminal information setting unit 236.

The virtual machine OS 231 is an OS that runs on a virtual machine.

The virtual machine application 232 is an application program that runs on the virtual machine OS 231.

The unique information storage unit 233 stores unique information, among terminal information that the virtualization hypervisor 220 acquires from the transfer platform 210.

The state information storage unit 234 stores state information, among the terminal information that the virtualization hypervisor 220 acquires from the transfer platform 210.

The setting information storage unit 235 stores setting information for setting, in the virtual machine 230, the terminal information that the virtualization hypervisor 220 acquires from the transfer platform 210.

The terminal information setting unit 236 sets unique information and state information, based on the setting information stored on the setting information storage unit 235.

In the server terminal device 200, there runs software such as the virtual machine OS 231 and the virtual machine application 232. The transfer platform 210 described in FIG. 1 transmits, to the client terminal device 100, a screen image generated by these pieces of software via a network. The client terminal device 100 receives this screen image, and displays the received screen image on a display provided in the client terminal device 100. A user views this display, and performs various operations on information included in the screen image by using an input device provided in the client terminal device 100. The client terminal device 100 transmits the operation information input by the user, to the server terminal device 200 via a network. In the server terminal device 200, the transfer platform 210 receives this operation information, and provides the received operation information to software to be operated. As such, in the thin client system 10, the server terminal device 200 transmits only a screen image, and transmits no actual data relating to processing on a server terminal device 200 side. On the other hand, the client terminal device 100 can operate software that runs on the server terminal device 200 by transmitting operation information. As such, the server terminal device 200 operates independently of the client terminal device 100 without exchanging actual data, while operating as if the server terminal device 200 are operated from an input device connected to the server terminal device 200. The server terminal device 200 and the client terminal device 100 are thereby separated, which makes it possible to construct a secure environment.

In such a general thin client system, a server terminal device operates independently of a client terminal device. Accordingly, although a user that utilizes a client terminal device utilizes software as if the software is running on the own device, the user sometimes cannot utilize a service that could have been utilized if the software is actually running on the own terminal device, and may feel inconvenient. In contrast to this, in the thin client system 10 having the above-mentioned configuration, terminal information on the client terminal device 100 is transmitted to the server terminal device 200. The terminal information can thereby be utilized by software (the virtual machine OS 231 and the virtual machine application 232) pertaining to a screen image that the client terminal device 100 utilizes. This can realize an operation of the software that actually operates on the server terminal device 200, similar to an operation of software that runs on the own terminal device. An operation of the thin client system 10 according to the present example embodiment will hereinafter be described.

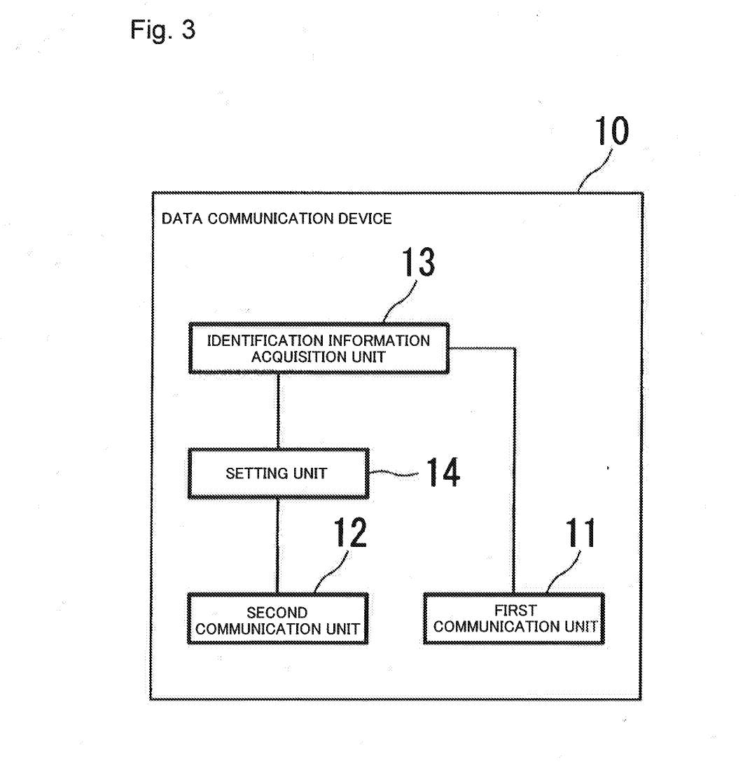

FIG. 3 is a diagram illustrating an example of setting information used for setting processing of terminal information according to the first example embodiment of the present invention.

FIG. 3 illustrates an example of setting information stored in the setting information storage unit 235. The setting information is reserved in the virtual machine 230, and is referred to when the virtual machine 230 acquires unique information and state information from the virtualization hypervisor 220. Recorded in the setting information is information such as whether or not the acquired unique information or state information is reflected in the unique information storage unit 233 or the state information storage unit 234 in the virtual machine 230. When the acquired unique information or state information is reflected, information of where to make overwrite is also recorded. Specifically, the setting information includes, for example, items of “client ID”, “terminal information type”, and “item” of a recipient, an item of “set/not set”, and items of “virtual machine”, “storage unit type”, and “item” of a setting target.

Data on the first row will be taken as an example for description. The setting information on the first row means that a value of “telephone number”, among “unique information” received from a “mobile terminal device A” connected to a “virtual machine 1”, is “set” as a value of “telephone number” in a “unique information storage unit” provided in the “virtual machine 1”. Furthermore, the third row, for example, means that even when “WIFI MAC address”, which is a type of the “unique information”, is received from the “mobile terminal device A” connected to the “virtual machine 1”, the received value is “not set” as a value of “WIFI MAC address” in the “unique information storage unit” provided in the “virtual machine 1”.

It is thereby possible to set, for example, whether or not a value of “IMEI” is reflected, whether or not a value of “telephone number” is reflected, and the like. It is noted that a content of setting information stored in the setting information storage unit 235 can be changed through a setting screen generated by the virtual machine 230 or the virtualization hypervisor 220.

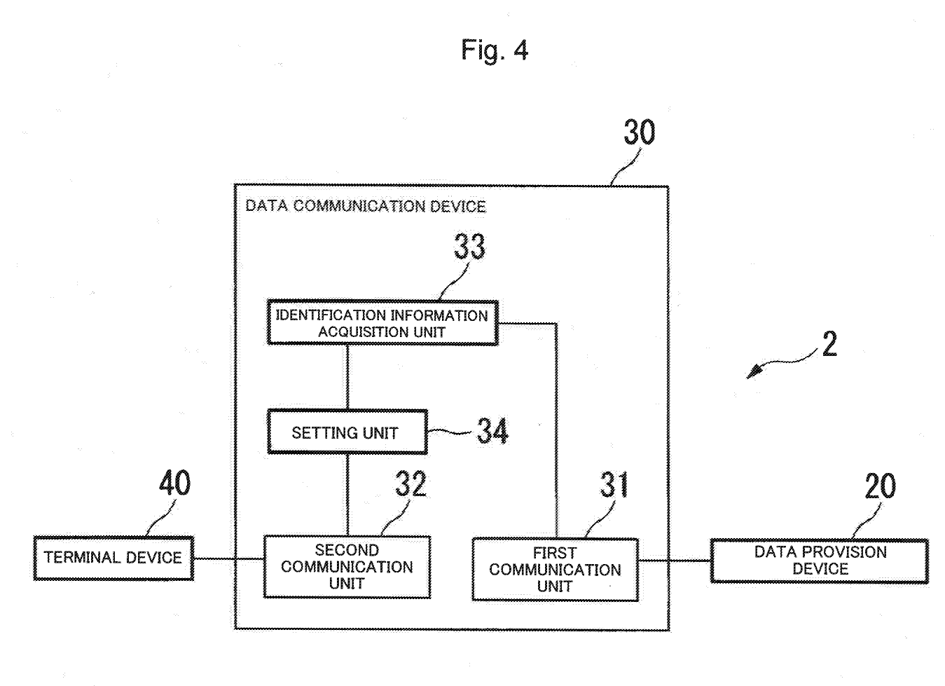

Next, FIG. 4 is used to describe processing of setting terminal information in the virtual machine 230.

FIG. 4 is a diagram for describing setting processing of terminal information performed by a terminal information setting unit in the first example embodiment of the present invention.

In FIG. 4, a functioning unit and the like relating to setting processing are described, while the descriptions of other configurations are omitted. It is premised that the virtual machine 230 runs on the virtualization hypervisor 220, with the client terminal device 100, not illustrated, being connected to the virtual machine 230. In the client terminal device 100, the virtual machine connecting unit 120 collects unique information and state information, and transmits these pieces of terminal information to the transfer platform 210 in the server terminal device 200. The transfer platform 210 receives these pieces of terminal information. FIG. 4 illustrates a state in which the transfer platform 210 has transferred the received terminal information to the virtualization hypervisor 220. The virtualization hypervisor 220 further transfers the received terminal information to the virtual machine 230. In the virtual machine 230, the terminal information setting unit 236 performs overwriting processing of the acquired terminal information, based on the setting information illustrated in FIG. 3.

Initially, unique information will be described. For example, it is assumed that the client terminal device 100 is the “mobile terminal device A”, and the virtual machine 230 is the “virtual machine 1”. The terminal information setting unit 236 performs processing of rewriting a value of “telephone number” stored in the unique information storage unit 233 with a value of the acquired “telephone number”, based on the setting information illustrated in FIG. 3. Similarly, the terminal information setting unit 236 rewrites a value of “IMEI” stored in the unique information storage unit 233 with a value of the acquired “IMEI”. Furthermore, the terminal information setting unit 236 does not overwrite values of “IMSI” and “WIFI MAC address” in the unique information storage unit 233. This is because, even when the terminal information setting unit 236 acquires a value of “IMSI” or “WIFI MAC address” from the virtualization hypervisor 220, these items are set to “not set” as setting information.

The same applies to state information. The terminal information setting unit 236 performs processing of rewriting a value of “radio field intensity” stored in the state information storage unit 234 with a value of the acquired “radio field intensity”, based on the setting information in FIG. 3. Similarly, the terminal information setting unit 236 rewrites a value of “battery remaining amount” stored in the state information storage unit 234 with a value of the acquired “battery remaining amount”. Furthermore, the terminal information setting unit 236 does not overwrite values of “communication state” and “line type” in the state information storage unit 234. This is because, even when the terminal information setting unit 236 acquires values of “communication state” and “line type” from the virtualization hypervisor 220, these items are set to “not set” as setting information.

As such, when terminal information is transmitted from the client terminal device 100, the terminal information setting unit 236 updates contents of the state information storage unit 234 and the unique information storage unit 233 by using the latest terminal information that is transmitted. Therefore, even when the client terminal device 100 moves and there is a change in radio wave state, for example, its state information can be reflected immediately in the virtual machine 230. Furthermore, the terminal information setting unit 236 sets terminal information, based on the setting information stored in the setting information storage unit 235 stores. Hence, when there is an item of unique information desired to be prohibited from use in terms of protection of privacy information and the like, for example, the item of the unique information can be prevented from use by setting the item not to be set in the “set/not set” item in the setting information.

Next, a flow of processing of transmitting/receiving terminal information will be described. Initially, unique information will be described.

FIG. 5 is a flowchart illustrating an example of transmission/reception processing of unique information performed by a thin client system in the first example embodiment of the present invention.

Initially, a user performs an activation operation of the virtual machine connecting unit 120 on the client terminal device 100. The user performs an operation such as inputting of authentication information on the activated virtual machine connecting unit 120, and performs an instruction operation that instructs connection to a virtual machine 230. Based on the instruction operation, the virtual machine connecting unit 120 then makes a connection request to the virtual machine 230 in the server terminal device 200 (step S11). Transmitted in the connection request are pieces of identification information, authentication information, and the like on the virtual machine 230 that is a connecting target. Based on the identification information on the virtual machine 230 included in the connection request, the transfer platform 210 performs processing of connecting to the specified virtual machine 230.

Furthermore, in the virtual machine 230, authentication processing is performed based on the authentication information included in the connection request, and when authentication succeeds, connection is established. When connection is established, the transfer platform 210 transmits, to the client terminal device 100, a screen image generated by the virtual machine 230.

Next, the virtual machine connecting unit 120 collects unique information (step S12). Specifically, the virtual machine connecting unit 120 reads and collects unique information such as IMEI or telephone number from the unique information storage unit 130. At this time, the virtual machine connecting unit 120 may read and collect all of the unique information stored in the unique information storage unit 130, or may read and collect only a part of the unique information stored in the unique information storage unit 130. For example, in response to the connection request at step S11, the virtual machine 230 refers to a setting content in the setting information storage unit 235, and transfers, to the transfer platform 210, an item of the unique information whose value in the “set/not set” field is set to be “set”. The transfer platform 210 transmits information on these items to the client terminal device 100 via a network. In the client terminal device 100, the virtual machine connecting unit 120 receives the information on the items. The virtual machine connecting unit 120 reads and collects only the received items from the unique information storage unit 130. Having collected unique information, the virtual machine connecting unit 120 then transmits, to the virtual machine 230 in the server terminal device 200, the collected unique information and identification information on a virtual machine that is a connecting target (step S13).

In the server terminal device 200, the transfer platform 210 receives the transmitted unique information and the like. Next, the transfer platform 210 transfers the received unique information and the like to the virtualization hypervisor 220 (step S14). The virtualization hypervisor 220 acquires the transferred unique information and the identification information on the virtual machine, and transfers the acquired unique information to the virtual machine 230 indicated by the identification information, among a plurality of virtual machines 230 that operate on the own platform (step S15).

Next, in the virtual machine 230, the terminal information setting unit 236 rewrites the unique information in the unique information storage unit 233 with the transferred unique information, based on the setting information stored in the setting information storage unit 235 (step S16). A specific method for rewriting processing is as described with use of FIGS. 3 and 4. Next, the virtual machine OS 231 and the virtual machine application 232 read, from the unique information storage unit 233, an item of the unique information necessary for executing a program, and utilize the unique information (step S17). A method of utilizing unique information possibly includes the following examples.

### (Utilization Method 1)

Among the unique information, IMEI, telephone number, and the like are utilized to perform authentication processing. Unique information on the client terminal device 100 is used to make authentication at the time of logging-in or utilizing an application on the virtual machine OS 231 or the virtual machine application 232. Thereby, it becomes possible to prevent a user other than a preset user from utilizing the virtual machine OS 231 or the virtual machine application 232 using an invalid client terminal device.

### (Utilization Method 2)

Among the unique information, information unique to a SIM card, such as IMSI or ICCID, is utilized in the virtual machine 230. It is thereby possible to utilize an original function and an original service provided by a communication carrier based on the IMSI or the like.

### (Utilization Method 3)

Among the unique information, the above-described information unique to a SIM card is used, for example. It is thereby possible to implement, in the virtual machine 230, a function such as language setting, time zone setting, network setting, or the like of the virtual machine OS 231.

### (Utilization Method 4)

Among the unique information, model number, screen size, resolution information, or the like is used. It is thereby possible to optimize screen size or layout setting of a screen image generated by the virtual machine OS 231 or the virtual machine application 232, and switch network setting according to data amount of a transmitted screen image. Furthermore, it is possible to switch setting for a specific device, for example, turning camera function OFF for the client terminal device 100 having no camera.

The virtual machine 230 that is a connecting target transmits, to the client terminal device 100, a screen image generated as a result of operation of the virtual machine OS 231 and the virtual machine application 232 by utilizing unique information, via the transfer platform 210 (step S18).

In general, when a screen transfer-type thin client system is used, it is not possible, for example, to use unique information on the client terminal device 100 in the virtual machine 230 that runs on the server terminal device 200. Accordingly, even when it is desired to utilize, in the virtual machine 230, an application that utilizes unique information on the client terminal device 100 for authentication processing, identification, or the like of a user, the application cannot be utilized because there is no way to transfer the unique information to the virtual machine 230.

According to the present example embodiment, unique information on the client terminal device 100 can be transferred to the virtual machine 230. It is therefore possible to install and utilize such an application that uses the unique information on the client terminal device 100 for authentication processing or identification of a user (an application assumed to be usually installed directly in the client terminal device 100), in the virtual machine 230 that runs on the remote server terminal device 200.

As described with use of FIG. 5, unique information is a value that does not change during utilization. Accordingly, unique information needs to be transferred only when connection is made to the virtual machine 230, for example. In contrast to this, state information is a value that changes according to a circumstance. Accordingly, the client terminal device 100 needs to transmit state information to the virtual machine 230 as appropriate. Next, transmission/reception of state information will be described.

FIG. 6 is a flowchart illustrating an example of transmission/reception processing of state information performed by the thin client system in the first example embodiment of the present invention.

State information is a value that varies during utilization. Therefore, state information is collected and transmitted, for example, at every predetermined time after connection is made to the virtual machine 230.

It is premised that connection to the virtual machine 230 has already been made. Furthermore, the client terminal device 100 is assumed to have a timer function.

The virtual machine connecting unit 120 determines whether or not a predetermined time (e.g., a few minutes) has elapsed after previous collection of state information, by utilizing a timer function (step S21). When the predetermined time has not elapsed (step S21: No), the virtual machine connecting unit 120 waits until the predetermined time elapses. When the predetermined time elapses (step S21: Yes), the virtual machine connecting unit 120 collects state information (step S22). Specifically, the virtual machine connecting unit 120 reads and collects state information such as radio field intensity or battery remaining amount from the state information storage unit 140. At this time, the virtual machine connecting unit 120 may read and collect all of the state information stored in the state information storage unit 140. Alternatively, the virtual machine connecting unit 120 may collect only an item whose state information is set to be “set” in the “set/not set” field in the setting information storage unit 235 of the virtual machine 230. Furthermore, although the state information is assumed to be read from the state information storage unit 140, the virtual machine connecting unit 120 may acquire information, such as radio field intensity, directly from each sensor that detects each piece of state information. Having collected the state information, the virtual machine connecting unit 120 then transmits, to the virtual machine 230 in the server terminal device 200, the collected state information and identification information on a virtual machine that is a connecting target (step S23).

In the server terminal device 200, the transfer platform 210 receives the transmitted state information and the like. Next, the transfer platform 210 transfers the received state information and the like to the virtualization hypervisor 220 (step S24). The virtualization hypervisor 220 acquires the transferred state information and the transferred identification information on the virtual machine, and transfers the acquired state information to the virtual machine 230 indicated by the identification information (step S25).

Next, in the virtual machine 230, the terminal information setting unit 236 rewrites the state information in the state information storage unit 234 with the transferred state information, based on the setting information stored in the setting information storage unit 235 (step S26). A specific setting method is as described with use of FIGS. 3 and 4. Next, the virtual machine OS 231 and the virtual machine application 232 read, from the state information storage unit 234, an item of the state information necessary for executing a program, and utilize the state information (step S27). A method of utilizing the state information possibly includes the following examples.

### (Utilization Method 5)

Among the state information, information such as radio field intensity, communication state, line type (WIFI (registered trademark), 3G, LTE, and the like) can be displayed on a desktop or a widget on a virtual machine 230 side. A user can thereby keep track of a communication state and the like while browsing a screen image generated by the virtual machine 230, without switching to a screen of an application that operates on the client terminal device 100. Furthermore, when a large amount of communication is made in the virtual machine application 232, it becomes possible to optimize the amount of communication by using, in advance, information that indicates a network state, such as radio field intensity, communication state, or line type.

### (Utilization Method 6)

Among the state information, information on connecting WIFI (registered trademark) indicated by line type is used. It becomes thereby possible to perform an operation such as allowing execution of a function of the virtual machine application 232 only when connection is made by a particular WIFI (registered trademark), the function being specified in advance.

### (Utilization Method 7)

Among the state information, information on battery remaining amount and battery charging/discharging state can be displayed on a desktop or a widget on the virtual machine 230 side. A user can thereby keep track of battery remaining amount and charging/discharging state while browsing a screen image generated by the virtual machine 230, without switching to a screen of an application that operates on the client terminal device 100. Furthermore, it becomes possible to implement a function such as displaying a warning before a battery of the client terminal device 100 runs out.

### (Utilization Method 8)

Among the state information, location information provided by GPS is used. It is thereby possible to utilize, in the virtual machine 230, a function of the virtual machine application 232 or the virtual machine OS 231 that uses location information, such as a map application. Furthermore, based on the location information, it becomes possible to switch settings of language and time zone of the virtual machine OS 231.

### (Utilization Method 9)

Among the state information, time-of-day information and time zone setting are used in such a way that language setting and time zone setting of the virtual machine OS 231 can be switched to settings similar to those of the client terminal device 100.

The virtual machine 230 that is a connecting target transmits, to the client terminal device 100, a screen image generated as a result of utilizing the latest state information by the virtual machine OS 231 or the virtual machine application 232, via the transfer platform 210 (step S28). Subsequently, whenever a predetermined time elapses, the client terminal device 100 repeatedly performs processing of collecting new state information (step S22) and the following processing.

In general, when a screen transfer-type thin client system is used, state information on the client terminal device 100 is utilized only within the client terminal device 100. Therefore, information such as network state (as to which of WIFI (registered trademark), any one of 3G, LTE, and 4G is used to connect to an internet), radio field intensity, battery remaining amount, and charging/discharging state of the client terminal device 100 cannot be utilized on the virtual machine 230 side. Accordingly, for example, when a user is to check these pieces of state information, he/she needs to check the state information by returning to a screen of the client terminal device 100 each time.

According to the present example embodiment, by operating the virtual machine application 232 that displays these pieces of state information, it is possible to keep track of network state, battery remaining amount, and the like while browsing only an image screen generated by the virtual machine 230. Furthermore, since state information can be updated, for example, at every predetermined time, a user can always keep track of the latest state information while continuously utilizing the virtual machine 230.

In FIGS. 5 and 6, an example of the transmission/reception processing of unique information and state information has been described. As another example of the processing, unique information may also be transmitted regularly as with state information.

Furthermore, as for state information, the virtual machine connecting unit 120 may monitor state information. When detecting a change in state information, the virtual machine connecting unit 120 may collect the state information and transmit it to the virtual machine 230.

Furthermore, as for both of unique information and state information, when the virtual machine application 232 and the virtual machine OS 231 make a request, the virtual machine connecting unit 120 may be triggered by the request to transmit a part or all of unique information and state information.

FIG. 7 is a diagram illustrating a utilization example of the thin client system according to the first example embodiment of the present invention.

FIG. 7 illustrates an example of accessing an intra-company system from outside a company, as a utilization example of the thin client system 10 in the present example embodiment.

In FIG. 7, the intra-company system is configured to include a client terminal device 100b, the server terminal device 200, and a server terminal device 300. The client terminal device 100b, the server terminal device 200, and the server terminal device 300 are connected via an intra-company network. Each of a client terminal device 100a and the client terminal device 100b is a mobile terminal device supplied by a company so that it can be utilized inside and outside the company. A backbone system of the company runs on the server terminal device 300. The server terminal device 300 executes authentication processing of determining an access authority on the client terminal device 100a or the like that is trying to connect to the backbone system. In particular, when the client terminal device 100a or the like is a mobile terminal device, there is adopted a mechanism that uses unique information on the mobile terminal device as a part of authentication information. Using unique information unique to a physical terminal device as a part of authentication information is more effective to prevent masquerading or the like than using an account for authentication, for example. In authentication processing of a mobile terminal device, unique information is thus often utilized as a part of authentication information. In a case of this example, when the client terminal device 100b is to connect to the server terminal device 300, it is assumed that unique information (e.g., IMEI) stored in a unique information storage unit 130b is set to be used for authentication processing even while the client terminal device 100b connects to the intra-company network. The virtual machine 230 runs on the server terminal device 200, and software α (the virtual machine application 232) for connecting to the backbone system in the server terminal device 300 is installed in the virtual machine 230.

On the other hand, the client terminal device 100a, which exists outside the company, becomes able to utilize the backbone system in the server terminal device 300 by utilizing the thin client system 10 of the present example embodiment. Specifically, the client terminal device 100a connects to the server terminal device 200. At this time, a physical machine connecting unit 120a reads information such as IMEI from a unique information storage unit 130a, and transmits the read unique information to the virtual machine 230 that is a connecting target. In the virtual machine 230, the terminal information setting unit 236 sets unique information.

Having connected to the virtual machine 230, a user inputs an instruction operation into the client terminal device 100a, operates the software α installed in the virtual machine 230, and connects to the backbone system that runs on the server terminal device 300. The software α reads a value of the IMEI that is received from the client terminal device 100a and is recorded in the unique information storage unit 233. The software α uses the read value of the IMEI as a part of authentication information, and undergoes authentication processing provided by the server terminal device 300. When the authentication processing succeeds, the virtual machine 230 becomes able to access the backbone system. Furthermore, a user of the client terminal device 100a becomes able to utilize the backbone system in the server terminal device 300 through the virtual machine 230 that runs on the server terminal device 200.

In a general thin client system, the virtual machine 230 accesses the backbone system in the server terminal device 300. Further, a user operates the virtual machine 230 via the client terminal device 100a and thereby utilizes the backbone system. In contrast to this, according to the thin client system 10 in the present example embodiment, the virtual machine 230 sets, in itself, the unique information and the state information transmitted from the client terminal device 100a, so that the virtual machine 230 can be operated as if it is the client terminal device 100a. A user utilizes the backbone system by operating the virtual machine 230 (a pseudo client terminal device 100a) via the client terminal device 100a. Accordingly, a user can utilize the backbone system as in a case where he/she connects directly to the server terminal device 300 from the client terminal device 100a. It is thereby possible for a user, even outside the company, to utilize the backbone system as in a case where he/she is inside the company. According to the thin client system 10 in the present example embodiment, it is possible to construct a system that has the above-described feature. This allows linkage with an intra-company system from a mobile terminal device outside a company, without significantly changing a network configuration and the like inside and outside the company, but with security ensured.

A screen image 101 in FIG. 7 shows a part of a screen image transmitted when connection is made from the client terminal device 100a to the intra-company server terminal device 300. The illustrated screen image 101 displays radio field intensity and battery remaining amount of the client terminal device 100a. When the client terminal device 100a is carried and utilized outside the company, there is a need for checking these pieces of state information at a glance. According to the present example embodiment, state information on the client terminal device 100a can be transmitted to the virtual machine 230. Hence, even when a screen image received from the virtual machine 230 is displayed on a whole screen, a user can check battery remaining amount and the like without switching a screen.

Although the case of using unique information when utilizing the server terminal device 300 (authentication processing) has been taken as an example, state information can also be used. For example, there is possibly an example of utilizing a service that utilizes location information on the client terminal device 100 with a map application running on the server terminal device 300, or other examples. In this case, software β (the virtual machine application 232) installed in the virtual machine 230 transmits, to the server terminal device 300, location information (state information) on the client terminal device 100 that is provided by GPS and is recorded in the state information storage unit 234, and executes the map application. The virtual machine 230 then transmits, to the client terminal device 100, a screen image that includes information on a result of the execution.

According to the present example embodiment, in a screen transfer-type thin client system, terminal information on the client terminal device 100 can be utilized transparently even on the server terminal device 200 side. Furthermore, the thin client system 10 in the present example embodiment is particularly effective when it is configured to have a mobile terminal device, whose unique information is often used for authentication and which is often used in an environment where its state information varies, as the client terminal device 100.

It is noted that although description has been made by taking a screen transfer-type thin client system of a virtual machine scheme as an example, the present example embodiment can also be applied to a screen transfer-type thin client system of another scheme. Examples of another scheme include a server base scheme, a blade PC scheme, and the like. When the present example embodiment is applied to these schemes, functions similar to those of the unique information storage unit 233, the state information storage unit 234, the setting information storage unit 235, and the terminal information setting unit 236 are assumed to be implemented in a physical OS implemented in a server terminal device, for example. Further, terminal information transmitted from a client terminal device is assumed to be recorded in a storage unit. Furthermore, in a multi-user environment in which a plurality of users simultaneously make access, terminal information may be recorded on a user-by-user basis.

Each of the client terminal device 100 and the server terminal device 200, which has been mentioned above, has a computer therein. A process of each processing in the client terminal device 100 and the server terminal device 200, which has been mentioned above, is stored in a computer-readable recording medium in a form of a program. The computer reads and executes this program, and thereby the above-described processing is performed. Here, the computer-readable recording medium means a magnetic disk, a magneto-optical disk, a CD-ROM, a DVD-ROM, a semiconductor memory, and the like. Furthermore, this computer program may be delivered to the computer over a communication line, and the computer that receives the delivery may execute the program.

Further, the above-described program may be for realizing a part of the above-mentioned functions. Furthermore, the above-described program may be a so-called differential file (differential program), which can realize the above-mentioned functions by combining with a program that has already been recorded in the computer system.

In addition, a component in the above-described example embodiment can be replaced with a well-known component as appropriate, as long as the replacement does not depart from a gist of the present invention. Furthermore, the technological scope of the present invention is not limited to the above-described example embodiment, and a variety of modifications can be added as long as the modifications do not depart from a gist of the present invention. The virtual machine connecting unit 120 is an example of a connecting unit. The server terminal device 300 is an example of an information processing device.

The present application claims priority based on Japanese Patent Application No. 2015-211802 filed on Oct. 28, 2015, the disclosure of which is incorporated herein in its entirety.

[Reference signs List]

| | |
|---|---|
| 10 | Thin client system |
| 100 | Client terminal device |
| 200 | Server terminal device |
| 110 | Physical machine OS |
| 120 | Virtual machine connecting unit |
| 130 | Unique information storage unit |
| 140 | State information storage unit |
| 210 | Transfer platform |
| 220 | Virtualization hypervisor |
| 230 | Virtual machine |
| 231 | Virtual machine OS |
| 232 | Virtual machine application |
| 233 | Unique information storage unit |
| 234 | State information storage unit |
| 235 | Setting information storage unit |
| 236 | Terminal information setting unit |

What is claimed is:

1. A server terminal device comprising:
a transfer platform that transmits, to a client terminal device, a screen image generated by software executed on the server terminal device, and receives, from the client terminal device, operation information relating to the screen image, wherein
the transfer platform further receives terminal information on the client terminal device from the client terminal device, and provides the received terminal information to the software.

2. The server terminal device according to claim 1, further comprising:
at least one virtual machine; and
a virtualization hypervisor that executes the virtual machine, wherein
the transfer platform transfers the terminal information to the virtualization hypervisor, and the virtualization hypervisor provides the terminal information for a virtual machine that operates on the virtualization hypervisor.

3. The server terminal device according to claim 2, wherein the virtual machine further includes
a terminal information setting unit that sets unique information and state information included in the terminal information, in a storage unit provided in the virtual machine, the unique information being unique information determined in relation to the client terminal device, the state information being information indicating a state relating to the client terminal device.

4. The server terminal device according to claim 3, wherein
the virtual machine executes an application that undergoes authentication processing that uses unique information on the client terminal device, the unique information being included in the terminal information.

5. The server terminal device according to claim 3, wherein
the virtual machine executes an application that displays state information on the client terminal device, the state information being included in the terminal information.

6. A client terminal device comprising:
a connecting unit that
receives a screen image from the server terminal device according to claim 1, and
transmits operation information relating to the screen image to the server terminal device, wherein
the connecting unit collects terminal information on the server terminal device, and transmits the collected terminal information to the server terminal device.

7. A thin client system comprising:
the server terminal device according to claim 1; and
a client terminal device which includes:
a connecting unit that receives a screen image from the server terminal device according to claim 1, and transmits operation information relating to the screen image to the server terminal device, wherein
the connecting unit collects terminal information on the server terminal device, and transmits the collected terminal information to the server terminal device.

8. The thin client system according to claim 7, further comprising:
an information processing device connected to the server terminal device, wherein
the server terminal device utilizes software that operates on the information processing device by using the terminal information.

9. A control method comprising:
by a server terminal device that transmits, to a client terminal device, a screen image generated by software executed on the server terminal device, and receives, from the client terminal device, operation information relating to the screen image,
receiving terminal information on the client terminal device from the client terminal device; and providing the received terminal information for the software.

10. A program recording medium that records a program causing a computer in a server terminal device that transmits, to a client terminal device, a screen image generated by software executed on the server terminal device, and receives, from the client terminal device, operation information relating to the screen image,
to function as means for receiving terminal information on the client terminal device from the client terminal device, and providing the received terminal information for the software.
